(19) United States
(12) Patent Application Publication
(10) Pub. No.: US 2008/0008964 A1
(43) Pub. Date: Jan. 10, 2008

(54) LIGHT EMITTING DIODE AND METHOD OF FABRICATING A NANO/MICRO STRUCTURE

(76) Inventors: Chia-Hua Chan, Keelung City, (TW); Jen-Inn Chyi, Taoyuan County (TW); Chang-Chi Pan, Pingtung County (TW); Chii-Chang Chen, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,168

(22) Filed: Jul. 5, 2006

(51) Int. Cl. B05D 5/00; G11B 7/24

(52) U.S. Cl. 430/270.13; 427/256

(57) ABSTRACT

A method of fabricating a nano/micro structure comprising the following steps is provided. First, a film is provided and then a mixed material comprising a plurality of particles and a filler among the particles is formed on the film. Next, the particles are removed by the etching process, the solvent extraction process or the like, such that a plurality of concaves is formed on the surface of the filler, which serves as a nano/micro structure of the film.

### BACKGROUND OF THE INVENTION

1. Field of the Invention

The present invention generally relates to a semiconductor light emitting device and a method of fabricating a nano/micro structure, and more particularly, to a light emitting diode (LED) and a method of fabricating one or more roughness layer in the LED for enhancing the extraction efficiency thereof.

2. Description of Related Art

The LED is a semiconductor element that has been widely used in light emitting devices. Generally, the LED chip is made up of III-V group compound semiconductors, such as GaP, GaAs, GaN and so on. The light emitting principle is to convert electrical energy into light, that is, a current is applied to the compound semiconductor, and by combining electrons with holes, the energy is converted into light so as to achieve the light emitting effect. Since LEDs have the advantages of rapid response speed (generally within about nano-second), preferable monochromaticity, small volume, low electrical power consumption, low pollution (free of mercury), high reliability, applicability for mass production processes, etc., they are widely used, such as in traffic light signals, display panels with large volumes, and display interfaces of various portable electronic devices, etc.

Basically, an LED comprises a P-type III-V group compound, an N-type III-V group compound, and a light emitting layer sandwiched there between, and is fabricated by means of epitaxy. The light emitting efficiency of the LED is the product of the internal quantum efficiency and the extraction efficiency thereof, which is called collectively as the external quantum efficiency. Since the LED has achieved the theoretical limit of the internal quantum efficiency, therefore, how to enhance the extraction efficiency of the LED is an important issue in this technology.

The light extraction efficiency of the LED is changed according to the geometry, the absorptivity, the scattering characteristics of the materials of the LED device, and the difference between the refraction index of the package material and that of the LED. To enhance the light extraction efficiency of the LED, one conventional technique is to roughen the surface of the LED substrate. The process includes roughening a surface of the LED substrate by etching to prevent the occurrence of total internal reflection of light inside the LED, which reduces the overall light utilization.

However, the surface roughness achieved by the etching process has the following disadvantages:

(1) Some substrates, such as sapphire substrates, are difficult to be etched and take longer etching processing time with effects on the productivity.

(2) Generally speaking, the photolithography and semiconductor process used for etching the substrate require expensive semiconductor equipments, and may lead to an increase on the fabrication cost of the LED.

### SUMMARY OF THE INVENTION

Accordingly, one purpose of the present invention is to provide a method of fabricating a nano/micro structure, suitable for forming a nano/micro structure having highly-ordered concaves on the LED substrate, thus reducing the fabrication time and cost.

A second purpose of the present invention is to provide an LED with a higher light emitting efficiency.

A third purpose of the present invention is to provide an LED having a lower fabrication cost.

A fourth purpose of the present invention is to provide an LED. The productivity of the LED is enhanced.

As embodied and broadly described herein, the present invention is directed to a method of fabricating a nano/micro structure. First, a film is provided and then a mixed material comprising a plurality of particles and a filler among the particles is formed on the film.

According to an embodiment of the present invention, after the mixed material is formed on the film, the particles are removed by the etching process, the thermal treatment process, the solvent extraction process or the like, such that a plurality of concaves is formed on the surface of the filler, which serves as a nano/micro structure of the film.

According to an embodiment of the present invention, the mixed material is formed on the surface of the film by spinning coating, dip coating or natural drying.

According to an embodiment of the present invention, a material of the particles comprises polymer, metal or metal oxide.

According to an embodiment of the present invention, the particles comprise a plurality of micro-scaled particles, a plurality of nano-scaled particles, or a mixture of the micro-scaled particles and the nano-scaled particles.

According to an embodiment of the present invention, a material of the filler comprises an inorganic material. Furthermore, the inorganic material comprises metal alkoxides, metal oxide precursor or a plurality of metal particles.

According to an embodiment of the present invention, the particles are removed by an etching process, a solvent extraction process or a thermal treatment process.

As embodied and broadly described herein, the present invention provides a light emitting diode comprising a substrate, a first roughness layer, a first type doped semiconductor layer, a light emitting layer, a second type doped semiconductor layer, a transparent conductive layer, a first electrode and a second electrode. The first roughness layer is disposed on the substrate, wherein a surface of the first roughness layer comprises a plurality of concaves. The first type doped semiconductor layer is disposed on the first roughness layer. The light emitting layer is disposed on a portion of the first type doped semiconductor layer. The second type doped semiconductor layer is disposed on the light emitting layer, wherein the second type doped semiconductor layer and the first type doped semiconductor layer are composed of a semiconductor material of a III-V group compound with different conductivity type. The transparent conductive layer is disposed on the second type doped semiconductor layer. The first electrode is disposed on the first type doped semiconductor layer. The second electrode is disposed on the transparent conductive layer, wherein the first electrode is electrically isolated from the second electrode.

According to an embodiment of the present invention, a material of the first roughness layer is the same or different from that of the substrate.

According to an embodiment of the present invention, a material of the first roughness layer comprises an inorganic material.

According to an embodiment of the present invention, the inorganic material comprises metal alkoxides, metal oxide precursor or a plurality of metal particles.

According to an embodiment of the present invention, the LED further comprises a second roughness layer disposed on the first type doped semiconductor layer, wherein a surface of the second roughness layer comprises a plurality of concaves.

According to an embodiment of the present invention, a material of the second roughness layer is the same or different from that of the first type doped semiconductor layer.

According to an embodiment of the present invention, a material of the second roughness layer comprises an inorganic material.

According to an embodiment of the present invention, the inorganic material comprises metal alkoxides, metal oxide precursor or a plurality of metal particles.

According to an embodiment of the present invention, the LED further comprises a third roughness layer disposed on the transparent conductive layer, wherein a surface of the third roughness layer comprises a plurality of concaves.

According to an embodiment of the present invention, a material of the third roughness layer is the same or different from that of the transparent conductive layer.

According to an embodiment of the present invention, a material of the third roughness layer comprises an inorganic material.

According to an embodiment of the present invention, the inorganic material comprises metal alkoxides, metal oxide precursor or a plurality of metal particles.

According to an embodiment of the present invention, the LED further comprises a second roughness layer and a third roughness layer, wherein the second roughness layer disposed on the first type doped semiconductor layer comprises a plurality of concaves, and the third roughness layer disposed on the transparent conductive layer also comprises a plurality of concaves.

According to an embodiment of the present invention, a material of the second roughness layer is the same or different from that of the first type doped semiconductor layer.

According to an embodiment of the present invention, a material of the third roughness layer is the same or different from that of the transparent conductive layer.

According to an embodiment of the present invention, a material of the second roughness layer and the third roughness layer comprises an inorganic material.

According to an embodiment of the present invention, the inorganic material comprises metal alkoxides, metal oxide precursor or a plurality of metal particles.

According to an embodiment of the present invention, a material of the substrate comprises sapphire, silicon carbide, zinc oxide, silicon, gallium arsenide, gallium nitride, aluminum nitride or AlGaN.

According to an embodiment of the present invention, the semiconductor material of the III-V group compound is InAlGaN:gallium nitride (GaN), gallium phosphide (GaP) or gallium phosphide arsenide (GaAsP).

According to an embodiment of the present invention, the first type doped semiconductor layer is comprised of an N-type doped layer, and the second type doped semiconductor layer is comprised of a P-type doped layer.

According to an embodiment of the present invention, the light emitting layer comprises a quantum-well light emitting layer.

According to an embodiment of the present invention, a material of the transparent conductive layer comprises indium tin oxide (ITO), cadmium tin oxide, ZnO:Al, ZnGa₂O4, SnO₂:Sb, Ga₂O₃:Sn, AgInO₂:Sn, In₂O₃:Zn, NiO, MnO, FeO, Fe₂O₃, CoO, CrO, Cr₂O₃, CrO₂, CuO, SnO, Ag₂O, CuAlO2, SrCu2O2, LaMnO3, PdO.

According to an embodiment of the present invention, a material of the first electrode comprise Ti/Al, Ti/Al/Ti/Au, Ti/Al/Pt/Au, Ti/Al/Ni/Au, Ti/Al/Pd/Au, Ti/Al/Cr/Au, Ti/Al/Co/Au, Cr/Al/Cr/Au, Cr/Al/Pt/Au, Cr/Al/Pd/Au, Cr/Al/Ti/Au, Cr/Al/Co/Au, Cr/Al/Ni/Au, Pd/Al/Ti/Au, Pd/Al/Pt/Au, Pd/Al/Ni/Au, Pd/Al/Pd/Au, Pd/Al/Cr/Au, Pd/Al/Co/Au, Nd/Al/Pt/Au, Nd/Al/Ti/Au, Nd/Al/Ni/Au, Nd/Al/Cr/Au, Nd/Al/Co/A, Hf/Al/Ti/Au, Hf/Al/t/Au, Hf/Al/Ni/Au, Hf/Al/Pd/Au, Hf/Al/Cr/Au, Hf/Al/Co/Au, Zr/Al/Ti/Au, Zr/Al/Pt/Au, Zr/Al/Ni/Au, Zr/Al/Pd/Au, Zr/Al/Cr/Au, Zr/Al/Co/Au, TiNₓ/Ti/Au, TiNₓ/Pt/Au, TiNₓ/Ni/Au, TiNₓ/Pd/Au, TiNₓ/Cr/Au, TiNₓ/Co/Au TiWNₓ/Ti/Au, TiWNₓ/Pt/Au, TiWNₓ/Ni /Au, TiWNₓ/Pd/Au, TiWNₓ/Cr/Au, TiWNₓ/Co/Au, NiAl/Pt/Au, NiAl/Cr/Au, NiAl/Ni/Au, NiAl/Ti/Au, Ti/NiAl/Pt/Au, Ti/NiAl/Ti/Au, Ti/NiAl/Ni/Au, Ti/NiAl/Cr/Au or the like.

According to an embodiment of the present invention, a material of the second electrode may comprise metallic alloys such as Ni/Au, Ni/Pt, Ni/Pd, Ni/Co, Pd/Au, Pt/Au, Ti/Au, Cr/Au, Sn/Au, Ta/Au, TiN, TiWNx, WSix or the like.

The roughness layer may be formed on one or more of the films of the LED, and the number and position of the roughness layer are not limited in the present invention.

In summary, the fabrication of the nano/micro structure may be applied to one or more of the films of the LED device to be roughed, such that the extraction efficiency of the LED device may be enhanced. Compared with the etching process, the fabrication method of the present invention may reduce the fabrication time and cost effectively, thus increasing the productivity of the LED device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A to 1C are schematic, cross-sectional diagrams illustrating the process flow for fabricating a nano/micro structure according to a preferred embodiment of the present invention.

FIG. 2 is a picture of a nano/micro structure formed according to the above-mentioned processes captured by an electron-microscope.

FIG. 3 is a cross-sectional view showing an LED device according to a preferred embodiment of the present invention.

FIG. 4 is a cross-sectional view showing an LED having two roughness layers according to another preferred embodiment of the present invention.

FIG. 5 is a cross-sectional view showing an LED having three roughness layers according to another preferred embodiment of the present invention.

FIG. 6 is a diagram illustrating a relationship of wavelength and RT-PL intensity measured from the standard 400 nm LED structure and the 400 nm LED structure on the substrate having the nano/micro structure according to an embodiment of the present invention.

FIG. 7 is a diagram illustrating a relationship of injection current and EL integrated intensity measured from the standard 400 nm LED structure and the 400 nm LED structure on the substrate having the nano/micro structure according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

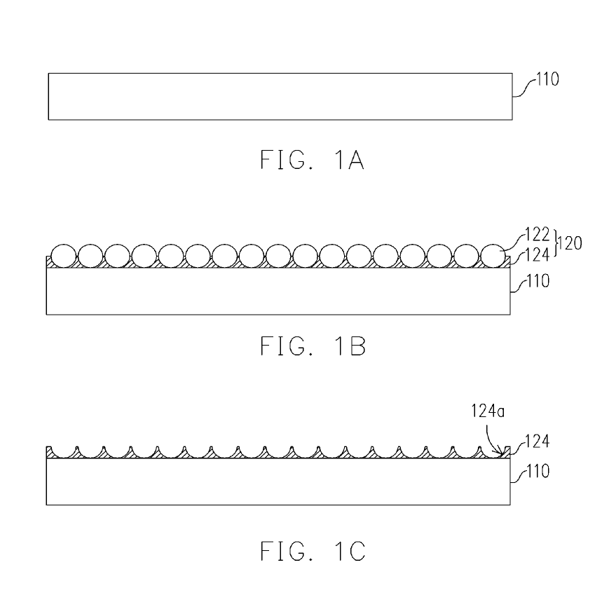

FIGS. 1A to 1C are schematic, cross-sectional diagrams illustrating the process flow for fabricating a nano/micro structure according to a preferred embodiment of the present invention. First, referring to FIG. 1A, a film 110 is provided. In one embodiment of the present invention, the film 110 may be the LED substrate, such as the sapphire substrate, or one of the films of the LED device, such as the N-type doped semiconductor layer, the P-type doped semiconductor layer or the transparent conductive layer to be roughed.

Then, please refer to FIG. 1B, a mixed material 120 is formed on the film 110, and the mixed material 120 comprises a plurality of particles 122 and a filler 124 among the particles 122. In this embodiment, the particles 122 and the filler 124 in liquid phase are mixed together in advance, and then a layer of the filler 124 and the particles 122 distributed therein is coated onto the film 110 by spinning coating. Basically, the mixed material 120 having the particles 122 has formed a nano/micro structure with a convex surface. However, if a nano/micro structure with a concave surface is desired, the user may need to proceed with the following step. By controlling a rotation speed of the spinning coating process, the particles 122 may be periodically arranged in a mono-layer on the film 110. Besides, the particles 122 may be arranged in two or more layers according to the concentration of the mixed solution coated on the film 110 and/or the rotation speed; however the number of the layers is not limited in the present invention. Except spinning coating, the mixed material 120 can be formed on the film 110 by dip coating, natural drying or other suitable method. The particles 122 may be in contact with the neighboring particles, or otherwise separated from each other as shown in FIG. 1B. In one embodiment of the present invention, the particles 122 may comprise a plurality of micro-scaled particles, a plurality of nano-scaled particles, or a mixture of the micro-scaled particles and the nano-scaled particles. The particles 122 may be made of polymer, metal or metal oxide. For example, the material of the polymer comprises polymethylmethacrylate (PMMA), polystyrene (PS) and so on; the material of the metal comprises gold, silver, copper, Ni, Ti, Al and the like; the material of the metal oxide comprises silicon dioxide, titanium dioxide and the like. Besides, a material of the filler 124 comprises an inorganic material, and the inorganic material may be metal alkoxides, metal oxide precursor or a plurality of metal particles.

Finally, please refer to FIG. 1C, the particles 122 are removed, such that a plurality of highly-ordered concaves 124a is formed on the surface of the filler 124, which serves as a nano/micro structure on the film 110. The size of the concaves 124a may be changed according to the diameter of the particles 122. Besides, according to an embodiment of the present invention, the particles 122 can be removed by the etching process, the solvent extraction process, the thermal treatment process or other suitable process. Thus far, the nano/micro structure on the film 110 is formed according to the above processes.

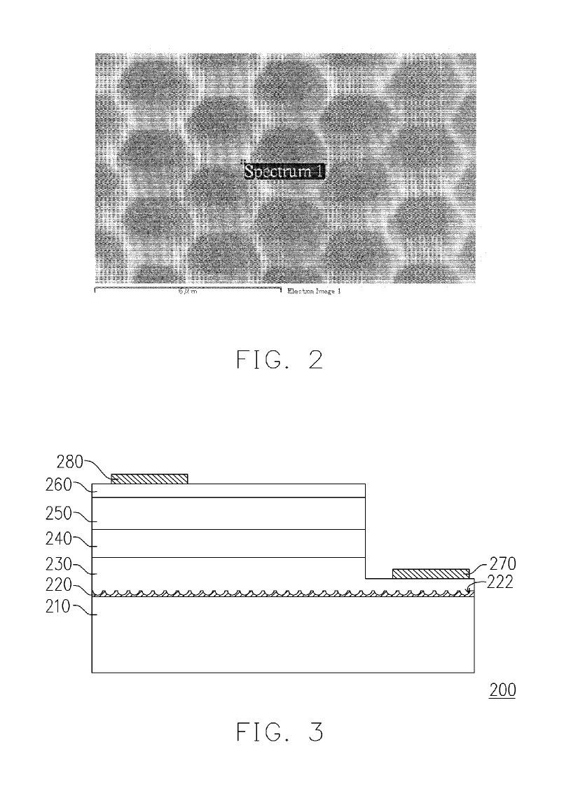

FIG. 2 is a picture of a nano/micro structure on a film formed according to the above-mentioned processes captured by an electron-microscope. The fabrication process of the nano/micro structure on the film comprises the following steps. First, a mixture of the micro-scaled styrene particles and the solution having aluminium particles is coated on the sapphire substrate. Then, the micro-scaled styrene particles are removed, such that a nano/micro structure, which is comprised of aluminium oxide and has a plurality of micro-scaled concaves, is formed on the sapphire substrate.

The fabrication of the nano/micro structure may be applied to any kinds of the light emitting devices for enhancing the light emitting efficiency thereof. In the present invention, the fabrication of the nano/micro structure is applied to one or more of the films of the LED device in order to avoid the occurrence of the total internal reflection. The LED devices having the nano/micro structure on one or more of the films are illustrated as follows.

FIG. 3 is a cross-sectional view showing an LED device according to a preferred embodiment of the present invention. Referring to FIG. 3, the LED 200 mainly comprises a substrate 210, a first roughness layer 220, a first type doped semiconductor layer 230, a light emitting layer 240, a second type doped semiconductor layer 250, a transparent conductive layer 260, a first electrode 270 and a second electrode 280. The first roughness layer 220 having a plurality of micro-scaled or nano-scaled concaves 222 is adapted to enhance the extraction efficiency of the LED 200 and is formed on the substrate 210 according to the above-mentioned processes. Furthermore, a material of the first roughness layer 220 depends on that of the precursor, and therefore the material of the first roughness layer 220 may be the same or different from that of the substrate 210. Then, an active layer constructed by the first type doped semiconductor layer 230, the light emitting layer 240 and the second type doped semiconductor layer 250 is formed, for example but not limited to, by performing a series of epitaxy processes sequentially on the first roughness layer 220. In this embodiment, the first type doped semiconductor layer 230 is an N-type doped semiconductor layer, and the second type doped semiconductor layer 250 is a P-type N-type doped semiconductor layer.

Moreover, in the succeeding process, a portion of the first type doped semiconductor layer 230, a portion of the light emitting layer 240 and a portion of the second type doped semiconductor layer 250 are removed, for example but not limited to, by etching or by another method, to form an isolated island structure (MESA). Then, the transparent conductive layer 260 is formed on the second type doped semiconductor layer 250. Finally, the first electrode 270 is formed on the exposed first type doped semiconductor layer 230, and the second electrode 280 electrically isolated from the first electrode 270 is formed on the transparent conductive layer 260. Since the surface of the substrate 210 is roughed by the fabrication of the first roughness layer 220, which does not require the etching process, therefore, the fabrication time and cost of the LED device can be reduced.

The substrate 210 may be a glass substrate, a silicon substrate, a sapphire substrate or the like. A material of the first roughness layer 220 comprises an inorganic material, such as metal alkoxides, metal oxide precursor or a plurality of metal particles. A material of the first type doped semiconductor layer 230 and the second type doped semiconductor layer 250 comprises a III-V group compound of semiconductor material, such as a gallium nitride (GaN), a gallium phosphide (GaP) or a gallium phosphide arsenide (GaAsP). The light emitting layer 240 may comprise a single or a multi quantum well structure, to enhance the light emitting efficiency. Besides, a material of the transparent conductive layer 260 preferably comprises an indium tin oxide (ITO), but also may comprise, for example but not limited to, such as indium tin oxide, cadmium tin oxide, ZnO:Al, ZnGa₂O4, SnO₂:Sb, Ga₂O₃:Sn, AgInO₂:Sn, In₂O₃:Zn, NiO, MnO, FeO, Fe₂O₃, CoO, CrO, Cr₂O₃, CrO₂, CuO, SnO, Ag₂O, CuAlO₂, SrCu₂O₂, LaMnO₃, PdO or the like. The first electrode 270 can be made of a metallic alloy including Ti/Al, Ti/Al/Ti/Au, Ti/Al/Pt/Au, Ti/Al/Ni/Au, Ti/Al/Pd/Au, Ti/Al/Cr/Au, Ti/Al/Co/Au, Cr/Al/Cr/Au, Cr/Al/Pt/Au, Cr/Al/Pd/Au, Cr/Al/Ti/Au, Cr/Al/Co/Au, Cr/Al/Ni/Au, Pd/Al/Ti/Au, Pd/Al/Pt/Au, Pd/Al/Ni/Au, Pd/Al/Pd/Au, Pd/Al/Cr/Au, Pd/Al/Co/Au, Nd/Al/Pt/Au, Nd/Al/Ti/Au, Nd/Al/Ni/Au, Nd/Al/Cr/Au, Nd/Al/Co/A, Hf/Al/Ti/Au, Hf/Al/t/Au, Hf/Al/Ni/Au, Hf/Al/Pd/Au, Hf/Al/Cr/Au, Hf/Al/Co/Au, Zr/Al/Ti/Au, Zr/Al/Pt/Au, Zr/Al/Ni/Au, Zr/Al/Pd/Au, Zr/Al/Cr/Au, Zr/Al/Co/Au, TiNₓ/Ti/Au, TiNₓ/Pt/Au, TiNₓ/Ni/Au, TiNₓ/Pd/Au, TiNₓ/Cr/Au, TiNₓ/Co/Au TiWNₓ/Ti/Au, TiWNₓ/Pt/Au, TiWNₓ/Ni/Au, TiWNₓ/Pd/Au, TiWNₓ/Cr/Au, TiWNₓ/Co/Au, NiAl/Pt/Au, NiAl/Cr/Au, NiAl/Ni/Au, NiAl/Ti/Au, Ti/NiAl/Pt/Au, Ti/NiAl/Ti/Au, Ti/NiAl/Ni/Au, Ti/NiAl/Cr/Au or the like. The material of the second electrode 270 may comprise metallic alloys such as Ni/Au, Ni/Pt, Ni/Pd, Ni/Co, Pd/Au, Pt/Au, Ti/Au, Cr/Au, Sn/Au, Ta/Au, TiN, TiWNₓ, WSiₓ or the like.

Besides, the roughness layer may be formed on one or more of the films of the LED to further enhance the extraction efficiency of the LED, and the number and position of the roughness layers are not limited in the present invention. The LED devices having two or more roughness layers are illustrated in the following.

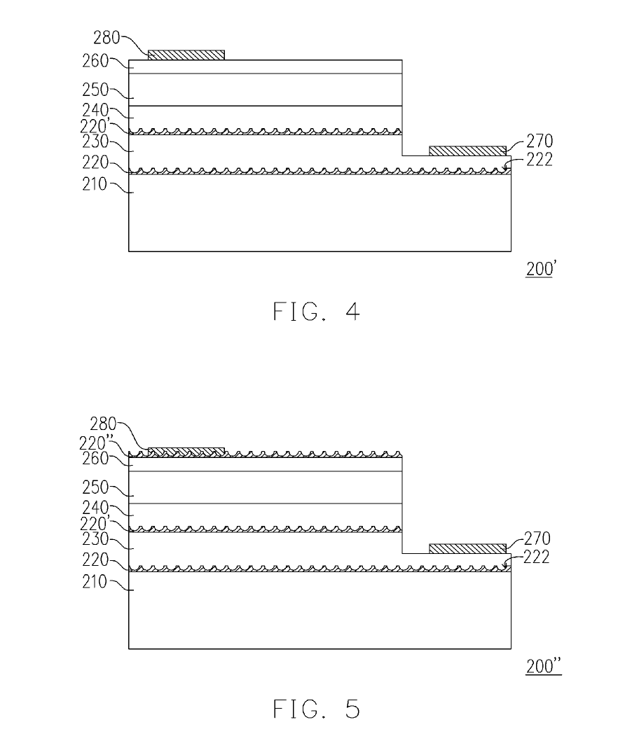

FIG. 4 is a cross-sectional view showing an LED having two roughness layers according to another preferred embodiment of the present invention. Please refer to FIG. 4, the structure of the LED 200′ is similar to that of the LED 200 shown in FIG. 3, and the difference between them lies in that the LED 200′ further comprises a second roughness layer 220′ disposed on the first type doped semiconductor layer 230. The structure and material of the second roughness layer 220′ are the same as those of the first roughness layer 220, and therefore it is not repeated herein.

FIG. 5 is a cross-sectional view showing an LED having three roughness layers according to another preferred embodiment of the present invention. Please refer to FIG. 5, the structure of the LED 200″ is similar to that of the LED 200′ shown in FIG. 4, and the difference between them lies in that the LED 200″ further comprises a third roughness layer 220″ disposed on the transparent conductive layer 260. The structure and material of the third roughness layer 220″ are the same as those of the first roughness layer 220, and therefore it is not repeated herein.

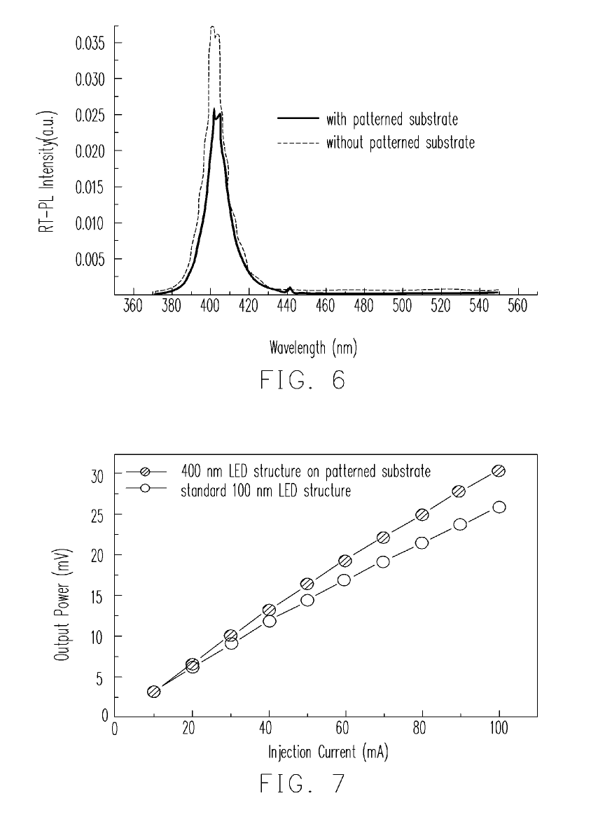

FIG. 6 is a diagram illustrating a relationship of wavelength and RT-PL intensity measured from the standard 400 nm LED structure and the 400 nm LED structure on the substrate having the nano/micro structure according to an embodiment of the present invention. FIG. 7 is a diagram illustrating a relationship of injection current and EL integrated intensity measured from the standard 400 nm LED structure and the 400 nm LED structure on the substrate having the nano/micro structure according to an embodiment of the present invention. It is clear from FIGS. 6 and 7, compared with the standard 400 nm LED structure, the RT-PL intensity and EL integrated intensity of the 400 nm LED structure on the substrate having the nano/micro structure are improved.

In summary, the present invention is to form a mixed material comprising a plurality of particles and the filler among the particles on the film. Then, the particles are removed by the etching process, the solvent extraction process or the thermal treatment process, such that the micro-scaled or nano-scaled concaves are formed on the surface of the filler, which serves as the nano/micro structure of the film. The fabrication of the nano/micro structure may be applied to one or more of the films of the LED device to be roughed, such that the extraction efficiency of the LED device may be enhanced. Compared with the etching process, the fabrication method of the present invention may reduce the fabrication time and cost effectively, thus increasing the productivity of the LED device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of fabricating a nano/micro structure, comprising:
providing a film; and
forming a mixed material on the film, wherein the mixed material comprises a plurality of particles and a filler among the particles.

2. The method of fabricating a nano/micro structure according to claim 1, wherein after the step of forming the mixed material on the film, the method further comprises a step of removing the particles, such that a plurality of concaves is formed on a surface of the filler, which serves as a nano/micro structure of the film.

3. The method of fabricating a nano/micro structure according to claim 1, wherein the mixed material is formed on the film by spinning coating, dip coating or natural drying.

4. The method of fabricating a nano/micro structure according to claim 1, wherein a material of the particles comprises polymer, metal or metal oxide.

5. The method of fabricating a nano/micro structure according to claim 1, wherein the particles comprise a plurality of micro-scaled particles, a plurality of nano-scaled particles, or a mixture of the micro-scaled particles and the nano-scaled particles.

6. The method of fabricating a nano/micro structure according to claim 1, wherein a material of the filler comprises an inorganic material.

7. The method of fabricating a nano/micro structure according to claim 6, wherein the inorganic material comprises metal alkoxides, metal oxide precursor or a plurality of metal particles.

8. The method of fabricating a nano/micro structure according to claim 1, wherein the particles are removed by an etching process, a solvent extraction process or a thermal treatment process.

9. A light emitting diode, comprising:
a substrate;
a first roughness layer, disposed on the substrate, wherein a surface of the first roughness layer comprises a plurality of concaves, and;
a first type doped semiconductor layer, disposed on the first roughness layer;
a light emitting layer, disposed on a portion of the first type doped semiconductor layer;
a second type doped semiconductor layer, disposed on the light emitting layer, wherein the second type doped semiconductor layer and the first type doped semiconductor layer are composed of a semiconductor material of a III-V group compound with different conductivity type;
a transparent conductive layer, disposed on the second type doped semiconductor layer;
a first electrode, disposed on the first type doped semiconductor layer; and
a second electrode, disposed on the transparent conductive layer, wherein the first electrode is electrically isolated from the second electrode.

10. The light emitting diode according to claim 9, wherein a material of the first roughness layer is the same or different from that of the substrate.

11. The light emitting diode according to claim 9, wherein a material of the first roughness layer comprises an inorganic material.

12. The light emitting diode according to claim 11, wherein the inorganic material comprises metal alkoxides, metal oxide precursor or a plurality of metal particles.

13. The light emitting diode according to claim 9, further comprising a second roughness layer disposed on the first type doped semiconductor layer, wherein a surface of the second roughness layer comprises a plurality of concaves.

14. The light emitting diode according to claim 13, wherein a material of the second roughness layer is the same or different from that of the first type doped semiconductor layer.

15. The light emitting diode according to claim 13, wherein a material of the second roughness layer comprises an inorganic material.

16. The light emitting diode according to claim 15, wherein the inorganic material comprises metal alkoxides, metal oxide precursor or a plurality of metal particles.

17. The light emitting diode according to claim 9, further comprising a third roughness layer disposed on the transparent conductive layer, wherein a surface of the third roughness layer comprises a plurality of concaves.

18. The light emitting diode according to claim 17, wherein a material of the third roughness layer is the same or different from that of the transparent conductive layer.

19. The light emitting diode according to claim 18, wherein a material of the third roughness layer comprises an inorganic material.

20. The light emitting diode according to claim 19, wherein the inorganic material comprises metal alkoxides, metal oxide precursor or a plurality of metal particles.

21. The light emitting diode according to claim 9, further comprising a second roughness layer and a third roughness layer, wherein the second roughness layer disposed on the first type doped semiconductor layer comprises a plurality of first concaves, and the third roughness layer disposed on the transparent conductive layer comprises a plurality of second concaves.

22. The light emitting diode according to claim 21, wherein a material of the second roughness layer is the same or different from that of the first type doped semiconductor layer.

23. The light emitting diode according to claim 21, wherein a material of the third roughness layer is different from that of the transparent conductive layer.

24. The light emitting diode according to claim 21, wherein a material of the second roughness layer and the third roughness layer comprises an inorganic material.

25. The light emitting diode according to claim 24, wherein the inorganic material comprises metal alkoxides, metal oxide precursor or a plurality of metal particles.

26. The light emitting diode according to claim 9, wherein a material of the substrate comprises sapphire, silicon carbide, zinc oxide, silicon, gallium arsenide, gallium nitride, aluminum nitride or AlGaN.

27. The light emitting diode according to claim 9, wherein the semiconductor material of the III-V group compound is gallium nitride (GaN), gallium phosphide (GaP) or gallium phosphide arsenide (GaAsP).

28. The light emitting diode according to claim 9, wherein the first type doped semiconductor layer is comprised of an N-type doped layer, and the second type doped semiconductor layer is comprised of a P-type doped layer.

29. The light emitting diode according to claim 9, wherein the light emitting layer comprises a quantum-well light emitting layer.

30. The light emitting diode according to claim 9, wherein a material of the transparent conductive layer comprises indium tin oxide (ITO), cadmium tin oxide, ZnO:Al, ZnGa2O4, SnO2:Sb, Ga2O3:Sn, AgInO2:Sn, In2O3:Zn, NiO, MnO, FeO, Fe2O3, CoO, CrO, Cr2O3, CrO2, CuO, SnO, Ag2O, CuAlO2, SrCu2O2, LaMnO3, PdO.

31. The light emitting diode according to claim 9, wherein a material of the first electrode comprises Ti/Al, Ti/Al/Ti/Au, Ti/Al/Pt/Au, Ti/Al/Ni/Au, Ti/Al/Pd/Au, Ti/Al/Cr/Au, Ti/Al/Co/Au, Cr/Al/Cr/Au, Cr/Al/Pt/Au, Cr/Al/Pd/Au, Cr/Al/Ti/Au, Cr/Al/Co/Au, Cr/Al/Ni/Au, Pd/Al/Ti/Au, Pd/Al/Pt/Au, Pd/Al/Ni/Au, Pd/Al/Pd/Au, Pd/Al/Cr/Au, Pd/Al/Co/Au, Nd/Al/Pt/Au, Nd/Al/Ti/Au, Nd/Al/Ni/Au, Nd/Al/Cr/Au, Nd/Al/Co/A, Hf/Al/Ti/Au, Hf/Al/t/Au, Hf/Al/Ni/Au, Hf/Al/Pd/Au, Hf/Al/Cr/Au, Hf/Al/Co/Au, Zr/Al/Ti/Au, Zr/Al/Pt/Au, Zr/Al/Ni/Au, Zr/Al/Pd/Au, Zr/Al/Cr/Au, Zr/Al/Co/Au, TiNx/Ti/Au, TiNx/Pt/Au, TiNx/Ni/Au, TiNx/Pd/Au, TiNx/Cr/Au, TiNx/Co/Au TiWNx/Ti/Au, TiWNx/Pt/Au, TiWNx/Ni/Au, TiWNx/Pd/Au, TiWNx/Cr/Au, TiWNx/Co/Au, NiAl/Pt/Au, NiAl/Cr/Au, NiAl/Ni/Au, NiAl/Ti/Au, Ti/NiAl/Pt/Au, Ti/NiAl/Ti/Au, Ti/NiAl/Ni/Au or Ti/NiAl/Cr/Au.

32. The light emitting diode according to claim 9, wherein a material of the second electrode comprises Ni/Au, Ni/Pt, Ni/Pd, Ni/Co, Pd/Au, Pt/Au, Ti/Au, Cr/Au, Sn/Au, Ta/Au, TiN, TiWNx or WSix.

33. A light emitting diode, comprising:
a substrate;
a first type doped semiconductor layer, disposed on the substrate;
a roughness layer, disposed on a portion of the first type doped semiconductor layer, wherein a surface of the roughness layer comprises a plurality of concaves, and a material of the roughness layer is different from that of the first type doped semiconductor layer;
a light emitting layer, disposed on the roughness layer;
a second type doped semiconductor layer, disposed on the light emitting layer, wherein the second type doped semiconductor layer and the first type doped semiconductor layer are composed of a semiconductor material of a III-V group compound with different conductivity type;
a transparent conductive layer, disposed on the second type doped semiconductor layer;
a first electrode, disposed on the first type doped semiconductor layer; and
a second electrode, disposed on the transparent conductive layer, wherein the first electrode is electrically isolated from the second electrode.

34. The light emitting diode according to claim 33, wherein a material of the roughness layer comprises an inorganic material.

35. The light emitting diode according to claim 34, wherein the inorganic material comprises metal alkoxides, metal oxide precursor or a plurality of metal particles.

36. The light emitting diode according to claim 33, further comprising another roughness layer disposed on the transparent conductive layer, a surface of the another roughness layer comprises a plurality of concaves.

37. The light emitting diode according to claim 36, wherein a material of the another roughness layer comprises an inorganic material.

38. The light emitting diode according to claim 37, wherein the inorganic material comprises metal alkoxides, metal oxide precursor or a plurality of metal particles.

39. The light emitting diode according to claim 33, wherein a material of the substrate comprises sapphire, silicon carbide, zinc oxide, silicon, gallium arsenide, gallium nitride, aluminum nitride or AlGaN.

40. The light emitting diode according to claim 33, wherein the semiconductor material of the III-V group compound is gallium nitride (GaN), gallium phosphide (GaP) or gallium phosphide arsenide (GaAsP).

41. The light emitting diode according to claim 33, wherein the first type doped semiconductor layer is comprised of an N-type doped layer, and the second type doped semiconductor layer is comprised of a P-type doped layer.

42. The light emitting diode according to claim 33, wherein the light emitting layer comprises a quantum-well light emitting layer.

43. The light emitting diode according to claim 33, wherein a material of the transparent conductive layer comprises indium tin oxide (ITO), cadmium tin oxide, ZnO:Al, ZnGa₂O4, SnO₂:Sb, Ga₂O₃:Sn, AgInO₂:Sn, In₂O₃:Zn, NiO, MnO, FeO, Fe₂O₃, CoO, CrO, Cr₂O₃, CrO₂, CuO, SnO, Ag₂O, CuAlO₂, SrCu₂O₂, LaMnO₃, PdO.

44. The light emitting diode according to claim 33, wherein a material of the first electrode comprises Ti/Al, Ti/Al/Ti/Au, Ti/Al/Pt/Au, Ti/Al/Ni/Au, Ti/Al/Pd/Au, Ti/Al/Cr/Au, Ti/Al/Co/Au, Cr/Al/Cr/Au, Cr/Al/Pt/Au, Cr/Al/Pd/Au, Cr/Al/Ti/Au, Cr/Al/Co/Au, Cr/Al/Ni/Au, Pd/Al/Ti/Au, Pd/Al/Pt/Au, Pd/Al/Ni/Au, Pd/Al/Pd/Au, Pd/Al/Cr/Au, Pd/Al/Co/Au, Nd/Al/Pt/Au, Nd/Al/Ti/Au, Nd/Al/Ni/Au, Nd/Al/Cr/Au, Nd/Al/Co/A, Hf/Al/Ti/Au, Hf/Al/t/Au, Hf/Al/Ni/Au, Hf/Al/Pd/Au, Hf/Al/Cr/Au, Hf/Al/Co/Au, Zr/Al/Ti/Au, Zr/Al/Pt/Au, Zr/Al/Ni/Au, Zr/Al/Pd/Au, Zr/Al/Cr/Au, Zr/Al/Co/Au, TiNₓ/Ti/Au, TiNₓ/Pt/Au, TiNₓ/Ni/Au, TiNₓ/Pd/Au, TiNₓ/Cr/Au, TiNₓ/Co/Au TiWNₓ/Ti/Au, TiWNₓ/Pt/Au, TiWNₓ/Ni/Au, TiWNₓ/Pd/Au, TiWNₓ/Cr/Au, TiWNₓ/Co/Au, NiAl/Pt/Au, NiAl/Cr/Au, NiAl/Ni/Au, NiAl/Ti/Au, Ti/NiAl/Pt/Au, Ti/NiAl/Ti/Au, Ti/NiAl/Ni/Au or Ti/NiAl/Cr/Au.

45. The light emitting diode according to claim 33, wherein a material of the second electrode comprises Ni/Au, Ni/Pt, Ni/Pd, Ni/Co, Pd/Au, Pt/Au, Ti/Au, Cr/Au, Sn/Au, Ta/Au, TiN, TiWNₓ or WSiₓ.

46. A light emitting diode, comprising:
a substrate;
a first type doped semiconductor layer, disposed on the substrate;
a light emitting layer, disposed on a portion of the first type doped semiconductor layer;
a second type doped semiconductor layer, disposed on the light emitting layer, wherein the second type doped semiconductor layer and the first type doped semiconductor layer are composed of a semiconductor material of a III-V group compound with different conductivity type;
a transparent conductive layer, disposed on the second type doped semiconductor layer;
a roughness layer, disposed on the transparent conductive layer, wherein a surface of the roughness layer comprises a plurality of concaves, and a material of the roughness layer is different from that of the transparent conductive layer;
a first electrode, disposed on the first type doped semiconductor layer; and
a second electrode, disposed on the roughness layer, wherein the first electrode is electrically isolated from the second electrode.

47. The light emitting diode according to claim 46, wherein a material of the roughness layer comprises an inorganic material.

48. The light emitting diode according to claim 47, wherein the inorganic material comprises metal alkoxides, metal oxide precursor or a plurality of metal particles.

49. The light emitting diode according to claim 46, wherein a material of the substrate comprises sapphire, silicon carbide, zinc oxide, silicon, gallium arsenide, gallium nitride, aluminum nitride or AlGaN.

50. The light emitting diode according to claim 46, wherein the semiconductor material of the III-V group compound is gallium nitride (GaN), gallium phosphide (GaP) or gallium phosphide arsenide (GaAsP).

51. The light emitting diode according to claim 46, wherein the first type doped semiconductor layer is comprised of an N-type doped layer, and the second type doped semiconductor layer is comprised of a P-type doped layer.

52. The light emitting diode according to claim 46, wherein the light emitting layer comprises a quantum-well light emitting layer.

53. The light emitting diode according to claim 46, wherein a material of the transparent conductive layer comprises indium tin oxide (ITO), cadmium tin oxide, ZnO:Al, ZnGa₂O4, SnO₂:Sb, Ga₂O₃:Sn, AgInO₂:Sn, In₂O₃:Zn, NiO, MnO, FeO, Fe₂O₃, CoO, CrO, Cr₂O₃, CrO₂, CuO, SnO, Ag₂O, CuAlO₂, SrCu₂O₂, LaMnO₃, PdO.

54. The light emitting diode according to claim 46, wherein a material of the first electrode comprises Ti/Al, Ti/Al/Ti/Au, Ti/Al/Pt/Au, Ti/Al/Ni/Au, Ti/Al/Pd/Au, Ti/Al/Cr/Au, Ti/Al/Co/Au, Cr/Al/Cr/Au, Cr/Al/Pt/Au, Cr/Al/Pd/Au, Cr/Al/Ti/Au, Cr/Al/Co/Au, Cr/Al/Ni/Au, Pd/Al/Ti/Au, Pd/Al/Pt/Au, Pd/Al/Ni/Au, Pd/Al/Pd/Au, Pd/Al/Cr/Au, Pd/Al/Co/Au, Nd/Al/Pt/Au, Nd/Al/Ti/Au, Nd/Al/Ni/Au, Nd/Al/Cr/Au, Nd/Al/Co/A, Hf/Al/Ti/Au, Hf/Al/t/Au, Hf/Al/Ni/Au, Hf/Al/Pd/Au, Hf/Al/Cr/Au, Hf/Al/Co/Au, Zr/Al/Ti/Au, Zr/Al/Pt/Au, Zr/Al/Ni/Au, Zr/Al/Pd/Au, Zr/Al/Cr/Au, Zr/Al/Co/Au, TiNₓ/Ti/Au, TiNₓ/Pt/Au, TiNₓ/Ni/Au, TiNₓ/Pd/Au, TiNₓ/Cr/Au, TiNₓ/Co/Au TiWNₓ/Ti/Au, TiWNₓ/Pt/Au, TiWNₓ/Ni/Au, TiWNₓ/Pd/Au, TiWNₓ/Cr/Au, TiWNₓ/Co/Au, NiAl/Pt/Au, NiAl/Cr/Au, NiAl/Ni/Au, NiAl/Ti/Au, Ti/NiAl/Pt/Au, Ti/NiAl/Ti/Au, Ti/NiAl/Ni/Au or Ti/NiAl/Cr/Au.

55. The light emitting diode according to claim 46, wherein a material of the second electrode comprises Ni/Au, Ni/Pt, Ni/Pd, Ni/Co, Pd/Au, Pt/Au, Ti/Au, Cr/Au, Sn/Au, Ta/Au, TiN, TiWNₓ or WSiₓ.
